(19) United States
(12) Patent Application Publication
(10) Pub. No.: US 2018/0104702 A1
(43) Pub. Date: Apr. 19, 2018

(54) VERTICAL DRUM DECANTER

(71) Applicant: Murukan Padmanabhan, Thiruvananthapuram, Kerala (IN)

(72) Inventor: Murukan Padmanabhan, Thiruvananthapuram, Kerala (IN)

(21) Appl. No.: 15/540,108

(22) PCT Filed: Jan. 1, 2015
(86) PCT No.: PCT/IB2015/050010

§ 371 Date: Jun. 27, 2017

(51) Int. Cl. B04B 1/14; B04B 11/02; B04B 9/12

(52) U.S. Cl. CPC B04B 1/14; B04B 9/12; B04B 11/02

(57) ABSTRACT

A machine is intended to separate the colloidal solids from a fluid by using centrifugal force. The machine has a vertical cylinder mounted at the end of a hollow shaft with sludge dispenser and clear water dispenser nozzles. The drum is rotated at high speed by a motor and pulley assembly fixed parallel. The effluent is fed to the separation chamber through the hollow shaft and the sludge is pushed out though the nozzles fixed at the periphery of the drum and clear water flows out through the nozzles fixed at the doubled chambered hollow shaft.

### TECHNICAL FIELD

A machine is used to separate colloidal solids and extract clear liquid from a mixture of solution by using centrifugal action. This machine employs a particular unique separator chamber, the details of which is explained below, to perform this action.

### BACKGROUND

The effective separation of solids from an effluent is a common requirement in many industries. I have been searching for a machine to separate sludge from the pretreated sewage after the settling tank and found those machines for my required flow rate is very costly. I ended up in the invention of this machine, having comparatively lower cost of production with effective performance.

### BRIEF DESCRIPTION OF THE DRAWINGS

FIG. 1 is an elevation and side view of a machine with separation chamber, in accordance with one embodiment of the Invention.

FIG. 2 schematically shows the flow pattern of FIG. 1 in accordance with one embodiment of the Invention.

FIG. 3 is a top view of separation chamber system, in accordance with one embodiment of the Invention.

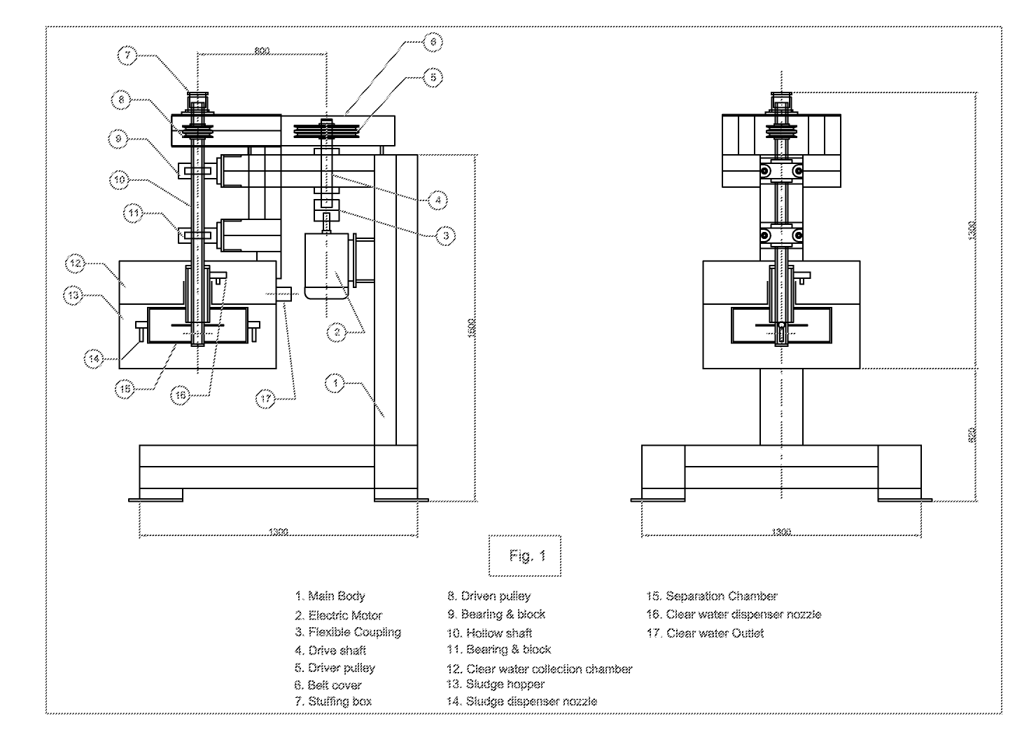

Machine Parts (FIG. 1)

1. Main Body

2. Electric Motor

3. Flexible Coupling

4. Drive Shaft

5. Driver Pulley

Belt Cover

Stuffing Box

Driven Pulley

Bearing & Block

Hollow Shaft

11. Bearing Block

12. Clear Water Chamber

13. Sludge Hopper

14. Sludge Dispenser Nozzle

15. Separation Chamber

16. Clear water Dispenser Nozzle

17. Clear Water Outlet

### DETAILED DESCRIPTION

FIG. 1 is a schematic diagram of a system with separation chamber, in accordance with one embodiment of the Invention. The separation chamber (FIG. 1, part No.15) is attached to the hollow shaft (FIG. 1, part No.10) and is a single unit. This unit is fixed to the main body (FIG. 1, part No.1) of the machine by means of two numbers of bearing & block (FIG. 1, part No. 9). At the top end of this unit, a small pulley (FIG. 1, part No.8) is fixed. This unit is subjected to high speed rotation with the help of a electric motor (FIG. 1, part No. 2) fixed on the main body (FIG. 1, part No.1) of the machine. Two numbers of sludge dispenser nozzles (FIG. 1, part No.14) and one clear water dispenser nozzle (FIG. 1, part No.16) are fixed on the separation chamber. The opening of these nozzles are closed with a pre-tensed spring and plate. The tension of the spring can be adjusted by tightening or loosening the bolt at the end of the nozzles, thus adjusting the pressure required to open the nozzles.

The effluent is fed through the stuffing box (FIG. 1, part No.7) at the end of the hollow shaft (FIG. 1, part No.10). While entering the separation chamber (FIG. 1, part No.15), the solid particles are directed to the periphery of the chamber due to the centrifugal force. The clear water at the center of the chamber is directed upwards through the hollow shaft and dispensed off through the clear water dispenser nozzle (FIG. 1, part No.16). The sludge accumulated at the periphery of the separation chamber (FIG. 1, part No.15) is pushed out though the sludge dispenser nozzle (FIG. 1, part No.14)

The clear water chamber (FIG. 1, part No. 12) and sludge hopper (FIG. 1, part No.13) are fixed to the main body and is stationary. The sludge can be collected by placing a skip under the sludge hopper (FIG. 1, part No.13). The clear water shall be directed to the collection point by a pipeline connected to the clear water outlet (FIG. 1, part No. 17) The driver pulley (FIG. 1, part No.5) installed on the drive shaft (FIG. 1, part No. 4) is connected to the driven pulley (FIG. 1, part No.8) by means of ‘V belts. The belt cover (FIG. 1, part No.6) is fixed on the main body (FIG. 1, part No.1). The drive shaft (FIG. 1, part No. 4) is rotating on two bearings and the lower end is connected to the motor shaft by means of flexible coupling(FIG. 1, part No.3)

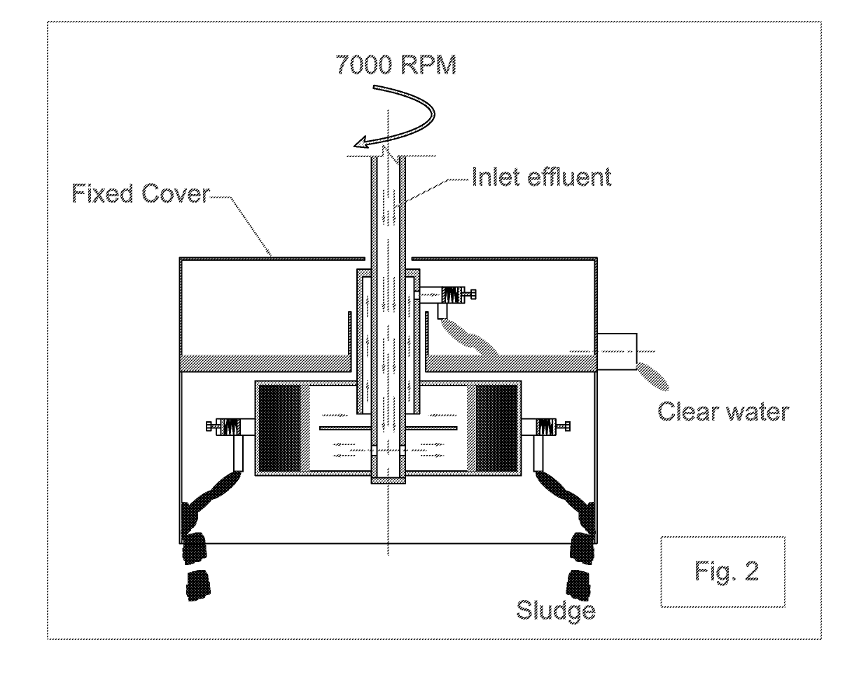

FIG. 2

FIG. 2 schematically shows the flow pattern of FIG. 1 in accordance with one embodiment of the Invention. Particulary, FIG. 2 shows the flow pattern of the mixture through the drum. Please note that the system is pressurized as the nozzles are closed by the spring loaded caps. The mixed liquor is pumped to the high speed rotating drum with pressure and it is spread out to the chambers through the holes provided at the bottom of the shaft. The solids begins to slide from the center to the outer part of the drum due to centrifugal action. The deflection plate provided above the holes prevent the solids directly passing to the clear water entry. Due to the pressure, the clear water is pushed above through the outer chamber of the double chambered shaft and pushed out through the clear water nozzle. At the same time the sludge is pushed out through the peripheral nozzles.

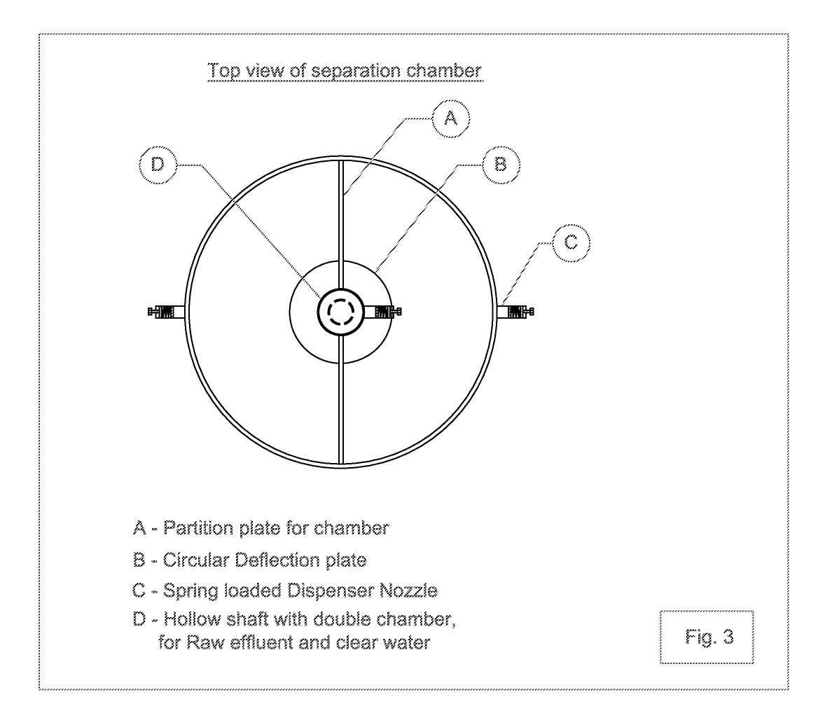

FIG. 3

FIG. 3 is a top view of separation chamber. This figure clearly shows the internal components of the drum. A partition plate (part no. A) provided right across the centre of the drum divides the drum in to two chambers. The partition plate also helps in preventing the mixture rotating along with the drum and thereby avoiding the creation of different relative velocity layers of the mixture. The part no. B is a deflector plate which helps to prevent any solids left from the bottom hole of the shaft, entering directly to the clear water outlet. The part no. D shows the main shaft with double chambers through which the mixture flows down and clear water flows up with the pressure. This figure also shows the nozzles and its location.

1. Having a vertical separation drum (FIG. 1 part No. 15) mounted at the end of a vertical hollow shaft (FIG. 1 part No. 10)

2. Having a drum as in claim 1 with spring loaded sludge dispenser nozzle (FIG. 3 part No. C)

3. Having a drum as in claim 1 with a circular deflection plate (FIG. 3 part No. B)

4. Having a drum as in claim 1 with a partition plate (FIG. 3 part No. A) to divide the chamber as two parts

5. Having a drum as in claim 1 with Double chambered hollow shaft (FIG. 3 part No. D) for raw water inlet and clear water outlet.

6. Having a drum as in claim 1 with the axis of the vertical drive shaft (FIG. 1 part No. 4) parallel to the axis of the hollow shaft (FIG. 1 part No. 10)

7. Having a separation drum (FIG. 1 part No. 15) at the lower end of the shaft and feed at the upper end of the hollow shaft (FIG. 1 part No. 10)
